(19) United States
(12) Patent Application Publication
(10) Pub. No.: US 2011/0080071 A1
(43) Pub. Date: Apr. 7, 2011

(54) BICYCLE POWER SUPPLY MODULE FOR SUPPLYING POWER TO ELECTRICAL DEVICES ON A BICYCLE AND RELATED BICYCLE

(76) Inventors: Tzu-Wei Liu, Taichung City (TW); Chian-Chi Huang, Taipei City (TW); Min-Feng Huang, Taipei City (TW)

(21) Appl. No.: 12/573,887

(22) Filed: Oct. 6, 2009

(51) Int. Cl. B62J 6/12; H02J 7/14

(52) U.S. Cl. 310/67 A; 320/163

(57) ABSTRACT

A bicycle power supply module is for supplying power to electrical devices on a bicycle. The bicycle power supply module includes a bicycle hub dynamo mounted on a hub of the bicycle for generating an AC power, an AC to DC converting module coupled to the bicycle hub dynamo for converting the AC power generated by the bicycle hub dynamo into a DC power, an energy storage module for storing electrical energy, and a charger coupled to the AC to DC converting module and the energy storage module for receiving the DC power converted by the AC to DC converting module and for charging the energy storage module with the DC power.

### BACKGROUND OF THE INVENTION

1. Field of the Invention

The present invention relates to a bicycle power supply module for supplying power to electrical devices on a bicycle and a related bicycle, and more particularly, to a bicycle power supply module for supplying power generated by a bicycle hub dynamo to a charger so as to charge an energy storage module on a bicycle and a related bicycle.

2. Description of the Prior Art

Electric generators, such as hub dynamos and tire dynamos, have been developed to supply electrical power to lamps installed on bicycles. Hub dynamos, as the name implies, are disposed within the hubs of bicycle wheels, typically the front wheels, and are typically installed during manufacturing of new bicycles. Despite the power supply for the lamp on the bicycle by the hub dynamo, current bicycle riders and sport enthusiasts remain unsatisfied and have the need for a long lasting, accessible, and convenient electrical power source during such activities as endurance races, training, recreational riding after work, commuting and others. For example, when the rider's portable electronic devices, such as a cell phone, a PDA, a MP3 player, GPS and so on, run out of electricity during riding exercise, it is inconvenient to charge the portable electronic devices, especially for the outdoors causing difficulty in finding charging means, such as a socket. Hence, there is a need to design a power supply mechanism equipped on a bicycle serving as an electricity storage device in accordance of an environmental design.

### SUMMARY OF THE INVENTION

An exemplary embodiment of a bicycle power supply module is disclosed. The bicycle power supply module is for supplying power to electrical devices on a bicycle. The bicycle power supply module includes a bicycle hub dynamo mounted on a hub of the bicycle for generating an AC power, an AC to DC converting module coupled to the bicycle hub dynamo for converting the AC power generated by the bicycle hub dynamo into a DC power, an energy storage module for storing electrical energy, and a charger coupled to the AC to DC converting module and the energy storage module for receiving the DC power converted by the AC to DC converting module and for charging the energy storage module with the DC power.

An another exemplary embodiment of a bicycle is disclosed. The bicycle includes a frame, and a wheel connected to the frame in a rotatable manner. The wheel includes a hub. The bicycle further comprises a bicycle power supply module installed on the frame. The bicycle power supply module includes a bicycle hub dynamo mounted on the hub for generating an AC power as the wheel rotates, an AC to DC converting module coupled to the bicycle hub dynamo for converting the AC power generated by the bicycle hub dynamo into a DC power, an energy storage module for storing electrical energy, and a charger coupled to the AC to DC converting module and the energy storage module for receiving the DC power converted by the AC to DC converting module and for charging the energy storage module with the DC power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a drawing of a bicycle according to a preferred embodiment of the present invention.

FIG. 2 is a functional block diagram of a bicycle power supply module according to the preferred embodiment of the present invention.

FIG. 3 is a drawing of a AC to DC converting module according to the preferred embodiment of the present invention.

### DETAILED DESCRIPTION

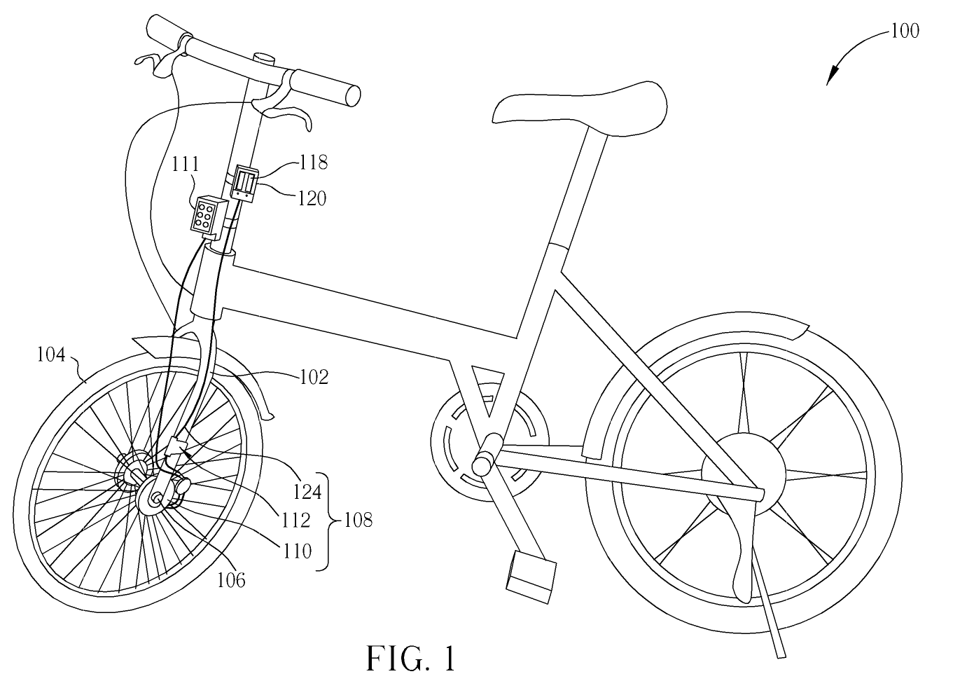

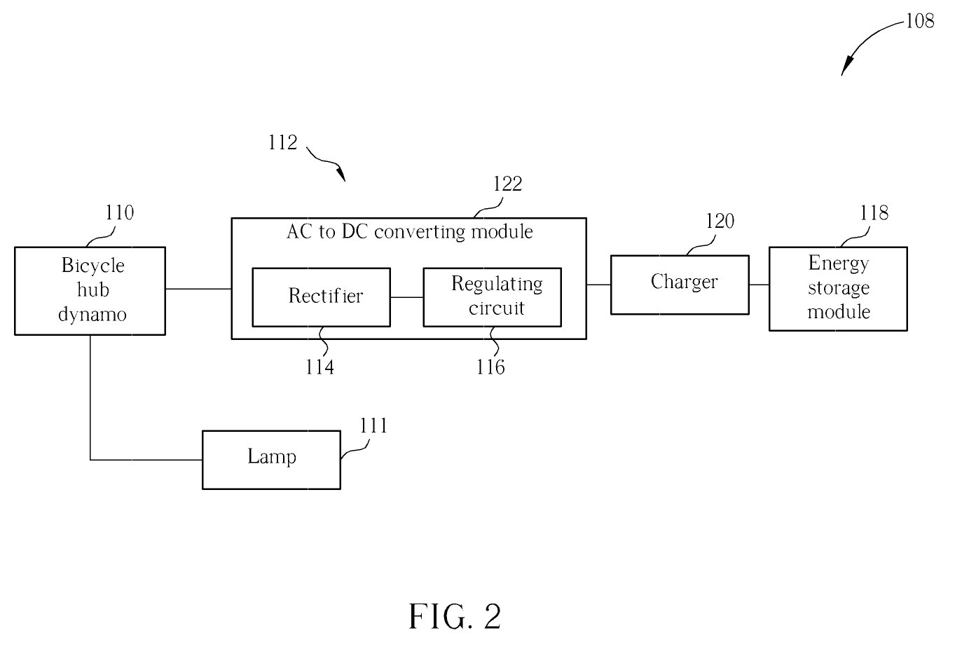

Please refer to FIG. 1. FIG. 1 is a drawing of a bicycle 100 according to a preferred embodiment of the present invention. The bicycle 100 includes a frame 102, and at least one wheel 104 connected to the frame 102 in a rotatable manner. The wheel includes a hub 106. The bicycle 100 further includes a bicycle power supply module 108 installed on the frame 102. Please refer to FIG. 1 and FIG. 2. FIG. 2 is a functional block diagram of the bicycle power supply module 108 according to the preferred embodiment of the present invention. The bicycle power supply module 108 includes a bicycle hub dynamo 110 mounted on the hub 106 for generating an alternating current (AC) power as the wheel 104 rotates. That is, the bicycle hub dynamo 110 uses the rotational movement energy of the wheel 104 of the bicycle 100 as its energy source. In this embodiment, the bicycle hub dynamo 110 is a front hub dynamo equipped in or on the hub 106 of the front wheel of the bicycle 100. The bicycle hub dynamo 110 also can be a rear hub dynamo equipped in or on the hub of the rear wheel of the bicycle 100. The bicycle 100 further includes a lamp 111 coupled to the bicycle hub dynamo 110 for receiving the AC power generated by the bicycle hub dynamo 110 so as to emit light. In general, at a traveling speed of approximately 15 km/h, the bicycle hub dynamo 110 will generate sufficient electrical power for the lamp 111.

The bicycle power supply module 108 further includes an AC to DC converting module 112 coupled to the bicycle hub dynamo 110 for converting the AC power generated by the bicycle hub dynamo 110 into a direct current (DC) power. Preferably, the AC to DC converting module 112 includes a rectifier 114 coupled to the bicycle hub dynamo 110 for converting an alternating current (AC) from the bicycle hub dynamo 110 into a direct current (DC), and a regulating circuit 116 coupled to the rectifier 114 for regulating a voltage of the DC converted by the rectifier 114 to a predetermined value, such as a DC voltage of 6 volts substantially.

In many cases, the bicycle hub dynamo 110 outputs an AC output voltage of 3 to 9 volts and has a power of 3 to 6 watts. An electromotive force of the bicycle hub dynamo 110 is roughly proportional to a traveling speed of the bicycle 100. For instance, the AC output voltage is 3 volts at a speed of 3 km/h, 7 volts at a speed of 10 km/h, 9 volts at a speed of 15 km/h, and so on. The AC power from the bicycle hub dynamo 110 is rectified by the rectifier 114 of the AC to DC converting module 112, such as a bridge circuit composed of rectifier diodes, and regulated into a DC voltage of 6 volts substantially by the regulating circuit 116.

The bicycle power supply module 108 further includes an energy storage module 118 for storing electrical energy. The energy storage module 118 can be a rechargeable battery. The bicycle power supply module 108 further includes a charger 120 coupled to the AC to DC converting module 112 and the energy storage module 118 for receiving the DC power converted by the AC to DC converting module 112 and for charging the energy storage module 118 with the DC power. The regulating circuit 116 is capable of regulating a voltage of the DC converted by the rectifier 114 to a predetermined value so as to provide a stable charging voltage for the charger 120 so that the charger 120 can charge the energy storage module 118 with the DC power stably. Then the charged energy storage module 118 can be taken apart from the charger 120 and be utilized for power source for other electronic devices. For example, when the rider's portable electronic devices, such as a cell phone, a PDA, a MP3 player, GPS and so on, run out of electricity during riding exercise, the charged energy storage module 118 can be utilized for charging the portable electronic devices conveniently so as to solve the conventional problem in searching charging means, such as a socket, in the outdoors.

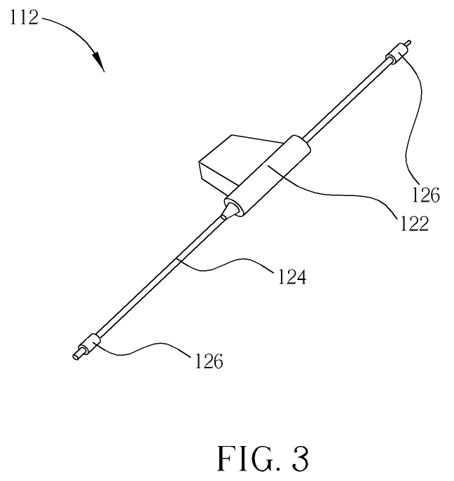

As shown in FIG. 1 and FIG. 2, the AC to DC converting module 112 further includes a housing 122 installed on the frame 102 for accommodating the rectifier 114 and the regulating circuit 116. The AC to DC converting module 112 further includes a cable 124 connected to the housing 122 for electrically connecting the bicycle hub dynamo 110 and the charger 120. That is, the AC to DC converting module 112 having the cable 124 and the housing 122 for accommodating the rectifier 114 and the regulating circuit 116 is a separate component for connecting the bicycle hub dynamo 110 and the charger 120. Please refer to FIG. 3. FIG. 3 is a drawing of the AC to DC converting module 112 according to the preferred embodiment of the present invention. The AC to DC converting module 112 further includes two connectors 126 connected to both ends of the cable 124 respectively for plugging into corresponding sockets of the bicycle hub dynamo 110 and the charger 120 so as to electrically connect the bicycle hub dynamo 110 and the charger 120. For above-mentioned structural design, the bicycle hub dynamo 110, the AC to DC converting module 112, and the charger 120 can be separate parts from one another so that the user can upgrade or replace the components easily. In another embodiment, the bicycle hub dynamo 110, the AC to DC converting module 112, and the charger 120 also can be integrated as one device.

In contrast to the prior art, the bicycle power supply module of the present invention is capable of utilizing the AC power generated by the bicycle hub dynamo to charge the lamp and of converting the AC power into the DC power for charging the energy storage module equipped on the bicycle simultaneously. It can provides bicycle riders and sport enthusiasts a long lasting, accessible, and convenient electrical power source during activities as endurance races, training, and recreational riding in accordance of an environmental design.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bicycle power supply module for supplying power to electrical devices on a bicycle, the bicycle power supply module comprising:
a bicycle hub dynamo mounted on a hub of the bicycle for generating an alternating current (AC) power;
an AC to DC converting module coupled to the bicycle hub dynamo for converting the AC power generated by the bicycle hub dynamo into a direct current (DC) power;
an energy storage module for storing electrical energy; and
a charger coupled to the AC to DC converting module and the energy storage module for receiving the DC power converted by the AC to DC converting module and for charging the energy storage module with the DC power.

2. The bicycle power supply module of claim 1 wherein the AC to DC converting module comprises:
a rectifier coupled to the bicycle hub dynamo for converting an AC from by the bicycle hub dynamo into a DC; and
a regulating circuit coupled to the rectifier and the charger for regulating a voltage of the DC converted by the rectifier to a predetermined value so as to provide a stable charging voltage for the charger.

3. The bicycle power supply module of claim 2 wherein the AC to DC converting module further comprises a housing for accommodating the rectifier and the regulating circuit.

4. The bicycle power supply module of claim 3 wherein the AC to DC converting module further comprises a cable connected to the housing for electrically connecting the bicycle hub dynamo and the charger.

5. The bicycle power supply module of claim 2 wherein the regulating circuit regulates the voltage of the DC converted by the rectifier to a DC voltage of 6 volts substantially.

6. The bicycle power supply module of claim 1 further comprising a lamp coupled to the bicycle hub dynamo for receiving the AC power generated by the bicycle hub dynamo so as to emit light.

7. The bicycle power supply module of claim 1 wherein the energy storage module is a rechargeable battery.

8. A bicycle comprising:
a frame;
a wheel connected to the frame in a rotatable manner, the wheel comprising a hub; and
a bicycle power supply module installed on the frame, the bicycle power supply module comprising:
a bicycle hub dynamo mounted on the hub for generating an alternating current (AC) power as the wheel rotates;
an AC to DC converting module coupled to the bicycle hub dynamo for converting the AC power generated by the bicycle hub dynamo into a direct current (DC) power;
an energy storage module for storing electrical energy; and
a charger coupled to the AC to DC converting module and the energy storage module for receiving the DC power converted by the AC to DC converting module and for charging the energy storage module with the DC power.

9. The bicycle of claim 8 wherein the AC to DC converting module comprises:
a rectifier coupled to the bicycle hub dynamo for converting an AC from the bicycle hub dynamo into a DC; and
a regulating circuit coupled to the rectifier and the charger for regulating a voltage of the DC converted by the rectifier to a predetermined value so as to provide a stable charging voltage for the charger.

10. The bicycle of claim 9 wherein the AC to DC converting module further comprises a housing installed on the frame for accommodating the rectifier and the regulating circuit.

11. The bicycle of claim 10 wherein the AC to DC converting module further comprises a cable connected to the housing for electrically connecting the bicycle hub dynamo and the charger.

12. The bicycle of claim 9 wherein the regulating circuit regulates the voltage of the DC converted by the rectifier to a DC voltage of 6 volts substantially.

13. The bicycle of claim 8 further comprising a lamp installed on the frame and coupled to the bicycle hub dynamo for receiving the AC power generated by the bicycle hub dynamo so as to emit light.

14. The bicycle of claim 8 wherein the energy storage module is a rechargeable battery.

15. The bicycle of claim 8 wherein the energy storage module and the charger are installed on the frame.
